(19) United States
(12) Patent Application Publication
(10) Pub. No.: US 2024/0401175 A1
(43) Pub. Date: Dec. 5, 2024

(54) SEMI-HARD MAGNETIC STEEL COMPONENT

(71) Applicant: Kabushiki Kaisha Kobe Seiko Sho (Kobe Steel, Ltd.), Kobe-shi (JP)

(72) Inventors: Kenshi IKEDA, Kobe-shi (JP); Shingo KASAI, Kobe-shi (JP); Shinya MORITA, Kobe-shi (JP); Yukihiro HISAI, Kobe-shi (JP)

(73) Assignee: Kabushiki Kaisha Kobe Seiko Sho (Kobe Steel, Ltd.), Kobe-shi (JP)

(21) Appl. No.: 18/702,107

(22) PCT Filed: Sep. 13, 2022
(86) PCT No.: PCT/JP2022/034269

§ 371 Date: Apr. 17, 2024

(30) Foreign Application Priority Data
Oct. 27, 2021 (JP) 2021-175794
Jul. 12, 2022 (JP) 2022-111740

(51) Int. Cl. C22C 38/42; C22C 38/00; C22C 38/02; C22C 38/04; C22C 38/06; C22C 38/44

(52) U.S. Cl. CPC C22C 38/42; C22C 38/002; C22C 38/02; C22C 38/04; C22C 38/06; C22C 38/44

(57) ABSTRACT

A semi-hard magnetic steel component including C: 0.60% by mass or more and 1.50% by mass or less, Si: more than 0% by mass and 0.75% by mass or less, Mn: more than 0% by mass and 1.00% by mass or less, P: more than 0% by mass and 0.050% by mass or less, S: more than 0% by mass and 0.050% by mass or less, Cu: more than 0% by mass and 0.30% by mass or less, Ni: more than 0% by mass and 0.30% by mass or less, Mo: more than 0% by mass and less than 0.30% by mass, Cr: 0.85% by mass or more and 2.00% by mass or less, Al: more than 0% by mass and 0.100% by mass or less, and N: more than 0% by mass and 0.0100% by mass or less, the balance being iron and inevitable impurities, wherein 80% by area or more of a tempered martensite phase is included, a half width of an X-ray diffraction peak from a (211) plane is 3.1° or less, an area ratio of carbides is 4.00% or more, and a Vickers hardness is 470 or less.

### TECHNICAL FIELD

The present disclosure relates to a semi-hard magnetic steel material and a semi-hard magnetic steel component.

### BACKGROUND ART

In recent years, there have been increasing an electromagnetic component that requires excellent magnetic properties during excitation and de-excitation. A semi-hard magnetic material having an intermediate coercivity (500 to 20,000 A/m) between a permanent magnet and a soft magnetic material is used for the component.

While the semi-hard magnetic material can usually exhibit soft magnetism as a material, the coercivity is made higher than that of the soft magnetic material by controlling the microstructure to suppress magnetic domain wall motion. The semi-hard magnetic material is generally required to have high squareness ratio depending on the magnitude of magnetic moment of a base material and the ease of magnetic domain wall motion, while having a coercivity of 500 to 20,000 A/m.

Patent Document 1 discloses a semi-hard magnetic steel material including 5.0% by mass or more of Ni. Patent Document 2 discloses a semi-hard magnetic steel material including 2.0% by mass or more of Cu. Non-Patent Document 1 discloses a Fe—Co—V-based semi-hard magnetic steel material (the Co content is, for example, 30% by mass or more, and the V content is, for example, 3% by mass or more).

### Conventional Art Document

### Patent Document

Patent Document 1: WO 2013/027665 A
Patent Document 2: JP 2008-274399 A

### Non-Patent Document

Non-Patent Document 1: Yasuo KIMIRA, “Current State of Semi-Hard Magnetic Materials”, Bulletin of the Japan Institute of Metals, 1970, Vol. 9, No. 11, p. 703-707

### DISCLOSURE OF THE INVENTION

### Problems to be Solved by the Invention

In the Conventional Art as disclosed in Patent Documents 1 to 2 and Non-Patent Document 1, all the semi-hard magnetic steel materials contain a large amount (for example, 2.0% by mass or more) of expensive elements such as Ni, Cu, Co and/or V. In such a case, the cost of raw materials may become extremely high, which may also lead to deterioration of the workability. Although simply reducing the amount of the above elements enables cost reduction and increase in magnetic moment, the elements are elements useful for suppressing magnetic domain wall motion. In the Conventional Art, reducing the magnetic domain wall motion suppression effect by reducing the elements has a greater influence on semi-hard magnetic properties than increasing the magnetic moment. That is, in the Conventional Art, reducing the amount of the elements enables significant deterioration of the semi-hard magnetic properties. Therefore, in the Conventional Art as disclosed in Patent Documents 1 to 2 and Non-Patent Document 1, it has been difficult to obtain a steel material having sufficient workability and sufficient semi-hard magnetic properties at low cost.

The present disclosure has been made in view of such circumstances, and one of objects thereof is to provide a semi-hard magnetic steel material and a semi-hard magnetic steel component, which are low cost and have sufficient workability and sufficient semi-hard magnetic properties.

### Means for Solving the Problems

Aspect 1 of the present invention provides a semi-hard magnetic steel component including:
C: 0.60% by mass or more and 1.50% by mass or less,
Si: more than 0% by mass and 0.75% by mass or less,
Mn: more than 0% by mass and 1.00% by mass or less,
P: more than 0% by mass and 0.050% by mass or less,
S: more than 0% by mass and 0.050% by mass or less,
Cu: more than 0% by mass and 0.30% by mass or less,
Ni: more than 0% by mass and 0.30% by mass or less,
Mo: more than 0% by mass and less than 0.30% by mass,
Cr: 0.85% by mass or more and 2.00% by mass or less,
Al: more than 0% by mass and 0.100% by mass or less, and
N: more than 0% by mass and 0.0100% by mass or less, with the balance being iron and inevitable impurities, wherein
80% by area or more of a tempered martensite phase is included,
a half width of an X-ray diffraction peak from the (211) plane is 3.1° or less,
an area ratio of carbides is 4.00% or more, and
a Vickers hardness is 470 or less.

Aspect 2 of the present invention provides the semi-hard magnetic steel component according to aspect 1, including more than 0% by mass and less than 0.05% by mass of Cu.

Aspect 3 of the present invention provides the semi-hard magnetic steel component according to aspect 1 or 2, including more than 0% by mass and less than 0.05% by mass of Ni.

Aspect 4 of the present invention provides the semi-hard magnetic steel component according to any one of aspects 1 to 3, including more than 0% by mass and less than 0.05% by mass of Mo.

Aspect 5 of the present invention provides the semi-hard magnetic steel component according to according to any one of aspects 1 to 4, wherein the Vickers hardness is 450 or less.

### Effects of the Invention

According to the embodiments of the present invention, it is possible to provide a semi-hard magnetic steel material and a semi-hard magnetic steel component, which are low cost and have sufficient workability and sufficient semi-hard magnetic properties.

### MODE FOR CARRYING OUT THE INVENTION

To realize a semi-hard magnetic steel material (and a semi-hard magnetic steel component), which are low cost and have sufficient workability and sufficient semi-hard magnetic properties, the inventors of the present invention have studied from different perspectives.

First, the inventors of the present invention have considered reducing the total content of expensive elements such as Ni, Cu, Co and/or V to less than 2.0% by mass (preferably less than 1.0% by mass) in order to realize low cost.

Within the limitation of the above composition, the inventors of the present invention have focused on the martensite phase in order to obtain sufficient semi-hard magnetic properties. The blocks (or packets) of the martensite phase can be made finer than crystal grains of the ferrite phase and, in that case, magnetic domain wall motion can be suppressed to obtain high semi-hard magnetic properties. Furthermore, the inventors of the present invention have focused on the tempered martensite phase with reduced strain in order to obtain sufficient workability, and found that there is a need for the tempered martensite phase to have at least a predetermined area ratio in order to obtain sufficient workability and sufficient semi-hard magnetic properties.

Furthermore, the inventors of the present invention have focused on the fact that a half width of a diffraction peak of an X-ray diffraction pattern indicates the degree of strain introduction. The inventors of the present invention have considered that the smaller the half peak width, the smaller the strain in the steel, leading to decreased hardness and improved workability of the steel. The inventors of the present invention have also considered that the smaller the half peak width, the smaller the strain, and the more the interaction due to the strain field decreases, leading to increased magnetic moment of the matrix phase and improved semi-hard magnetic properties.

Thus, the inventors of the present invention have found that a steel material, which is low-cost and has sufficient workability and sufficient semi-hard magnetic properties, can be obtained by controlling the composition within a predetermined composition range, increasing an area ratio of the tempered martensitic phase to a predetermined value or more, and reducing a half width of an X-ray diffraction peak from the (211) plane to a predetermined value or less.

Details of the respective requirements specified by the embodiments of the present invention are shown below. Regarding a difference between “steel material” and “steel component” as used herein, “steel material” refers to those which are not subjected to component forming, while “steel component” refers to those which are subjected to component forming. For example, the steel material can be in a simple shape extending linearly in one direction, such as a cylindrical or rectangular shape, as a result of rolling and/or wire drawing. Meanwhile, the steel component can be in a complex shape which do not extend linearly in one direction, such as a shape having a ground, bent and/or opening portions, as a result of further component forming such as forging or cutting, in addition to rolling and/or wire drawing.

The term “semi-hard magnetic steel material” as used herein means a steel material having a coercivity of 500 to 20,000 A/m, and the term “semi-hard magnetic steel component” means a steel component having a coercivity of 500 to 20,000 A/m.

### <1. Composition>

In the semi-hard magnetic steel material (or semi-hard magnetic steel component) according to the embodiments of the present invention, it is preferable that the composition thereof includes C: 0.10% by mass or more 1.50% by mass or less, Si: more than 0% by mass and 0.75% by mass or less, Mn: more than 0% by mass and 1.00% by mass or less, P: more than 0% by mass and 0.050% by mass or less, S: more than 0% by mass and 0.050% by mass or less, Cu: more than 0% by mass and 0.30% by mass or less, Ni: more than 0% by mass and 0.30% by mass or less, Mo: more than 0% by mass and 1.00% by mass or less, Cr: 0.50% by mass or more 2.00% by mass or less, Al: more than 0% by mass and 0.100% by mass or less, and N: more than 0% by mass and 0.0100% by mass or less, with the balance being iron and inevitable impurities.

Hereinafter, the respective elements will be described in detail.

### (C: 0.10% by Mass or More and 1.50% by Mass or Less)

C forms carbides and contributes to an improvement in semi-hard magnetic properties by the effect of suppressing magnetic domain wall motion due to the carbides (i.e., pinning effect of magnetic domain wall motion). To effectively exert the above effect, the C content is set at 0.10% by mass or more. The C content is preferably 0.15% by mass or more, more preferably 0.18% by mass or more. The C content is more preferably 0.25% by mass or more, 0.32% by mass or more, 0.39% by mass or more, 0.46% by mass or more, 0.53% by mass or more, 0.60% by mass or more, or 0.65% by mass or more in this order. Furthermore, when the C content is 0.25% by mass or more and the temperature for high-temperature holding of a quenching treatment step is 780 to 950° C., the below-mentioned area ratio of carbides can be increased to 4.00% or more (however, when the temperature for high-temperature holding of the treatment step is 900° C. or higher, there is a need to further adjust the temperature for high-temperature holding of a tempering treatment step as mentioned below), which is preferable because it enables further improvement in semi-hard magnetic properties.

The excessive C content increases the hardness after quenching and tempering, leading to deterioration of the workability. Therefore, the C content is set at 1.50% by mass or less. The C content is preferably 1.30% by mass or less, and more preferably 1.20% by mass or less.

(Si: More than 0% by Mass and 0.75% by Mass or Less)

Si effectively acts as a deoxidizer and also contributes to an improvement in semi-hard magnetic properties. To effectively exert these effects, the Si content is set at more than 0% by mass. The Si content is preferably 0.010% by mass or more, more preferably 0.050% by mass or more, and still more preferably 0.10% by mass or more.

The excessive Si content reduces the magnetic moment, leading to deterioration of the semi-hard magnetic properties. The excessive Si content also increases the hardness after quenching and tempering due to solid-solution strengthening or the like, leading to deterioration of the workability. Therefore, the Si content is set at 0.75% by mass or less. The Si content is preferably 0.65% by mass or less, more preferably 0.55% by mass or less, and still more preferably 0.35% by mass or less.

(Mn: More than 0% by Mass and 1.00% by Mass or Less)

Mn is an element that acts as a deoxidizer and also contributes to an improvement in hardenability. To sufficiently exert the above effects, the Mn content is set at more than 0% by mass. The Mn content is preferably 0.05% by mass or more, more preferably 0.10% by mass or more, and still more preferably 0.20% by mass or more.

The excessive Mn content reduces the magnetic moment, leading to deterioration of the semi-hard magnetic properties. The excessive Mn content also increases the hardness after quenching and tempering due to solid-solution strengthening or the like, leading to deterioration of the workability. Therefore, the Mn content is set at 1.00% by mass or less. The Mn content is preferably 0.95% by mass or less, more preferably 0.90% by mass or less, and still more preferably 0.85% by mass or less.

(P: More than 0% by Mass and 0.050% by Mass or Less)

P (phosphor) is an inevitable impurity, and is a harmful element which causes grain boundary segregation in the steel and exerts an adverse influence on the toughness. Therefore, the P content is set at 0.050% by mass or less. The P content is preferably 0.030% by mass or less, and more preferably 0.020% by mass or less. P is usually preferred in a smaller amount, and more than 0% by mass of P may be included and 0.001% by mass or more of P may be sometimes included.

(S: More than 0% by Mass and 0.050% by Mass or Less)

S (sulfur) is an inevitable impurity, and is an element harmful to the workability since it forms MnS in the steel to cause deterioration of the ductility. Therefore, the S content is set at 0.050% by mass or less. The S content is preferably 0.030% by mass or less, more preferably 0.020% by mass or less, and still more preferably 0.010% by mass or less. S is usually preferred in a smaller amount, and more than 0% by mass of S may be included and 0.001% by mass or more of S may be sometimes included.

(Cu: More than 0% by Mass and 0.30% by Mass or Less, Ni: More than 0% by Mass and 0.30% by Mass or Less, Mo: More than 0% by Mass and 1.00% by Mass or Less)

All the Cu, Ni and Mo are elements that improve the hardenability of a steel material (or a steel component), and contributes to an improvement in semi-hard magnetic properties. Therefore, each content of Cu, Ni and Mo is set at more than 0% by mass. However, the excessive content of these elements increases the harness after quenching and tempering, leading to deterioration of the workability. Furthermore, the excessive content may reduce the magnetic moment and may cause deterioration of the semi-hard magnetic properties. Thus, each content of Cu and Ni is set at 0.30% by mass or less, and the content of Mo is set at 1.00% by mass or less. Each content of Cu and Ni is preferably 0.25% by mass or less, more preferably 0.20% by mass or less, and still more preferably 0.10% by mass or less. From the viewpoint of further reducing the cost, the content of Cu is more preferably less than 0.05% by mass. Similarly, from the viewpoint of further reducing the cost, the content of Ni is more preferably less than 0.05% by mass. The Mo content is preferably 0.50% by mass or less, more preferably 0.30% by mass or less, still more preferably less than 0.30% by mass, and yet more preferably 0.20% by mass or less. From the viewpoint of further reducing the cost, the content of Mo is more preferably less than 0.05% by mass.

### (Cr: 0.50% by Mass or More 2.00% by Mass or Less)

Cr improves the hardenability of the steel and forms carbides and/or nitrides, thus contributing to an improvement in semi-hard magnetic properties by the effect of suppressing magnetic domain wall motion due to precipitates (i.e., pinning effect of magnetic domain wall motion) without significantly reducing the magnetic moment. To effectively exert these effects, the Cr content is 0.50% by mass or more, preferably 0.70% by mass or more, more preferably 0.85% by mass or more, still more preferably 0.90% by mass or more, and yet more preferably 0.95% by mass or more.

The excessive Cr content reduces the magnetic moment, leading to deterioration of the semi-hard magnetic properties. The excessive Cr content also increases the hardness after quenching and tempering due to solid-solution strengthening, leading to deterioration of the workability. Therefore, the Cr content is set at 2.00% by mass or less. The Cr content is preferably 1.75% by mass or less, and more preferably 1.60% by mass or less. (Al: More than 0% by Mass and 0.100% by Mass or Less)

Al is an element that effectively acts as a deoxidizer, and has the effect of reducing impurities in association with deoxidation. To effectively exert this effect, the Al content is set at more than 0% by mass. The Al content is preferably 0.005% by mass or more, and more preferably 0.010% by mass or more.

The excessive Al content increases nonmetallic inclusions, leading to deterioration of the toughness and workability. Therefore, the Al content is set at 0.100% by mass or less. The Al content is preferably 0.080% by mass or less, more preferably 0.050% by mass or less, and still more preferably 0.040% by mass or less.

(N: More than 0% by Mass and 0.0100% by Mass or Less)

N is an impurity included inevitably in the steel, and when a large amount of solid-soluted N is included in the steel, an increase in hardness due to strain aging and deterioration of the ductility occur, leading to deterioration of the workability. Therefore, the N content is set at 0.0100% by mass or less, and is preferably 0.0090% by mass or less, more preferably 0.0080% by mass or less, and still more preferably 0.0070% by mass or less.

The semi-hard magnetic steel material (or semi-hard magnetic steel component) according to the embodiments of the present invention has the above composition and, in one embodiments of the present invention, the balance preferably includes iron and inevitable impurities. As inevitable impurities, mixing of trace elements (for example, As, Sb, Sn, etc.) brought in steel material is permitted, depending on the circumstances including raw materials, source materials, production facilities and the like. There are some elements, such as P, S and N, for example, which are inevitable impurities that are usually preferred in smaller amounts and whose composition range is separately specified as mentioned above. For this reason, “inevitable impurities” as used herein is the concept excluding an element, the composition range of which is separately specified.

### <2. Microstructure>

The semi-hard magnetic steel material (or semi-hard magnetic steel component) according to the embodiments of the present invention includes 80% by area or more of a tempered martensite phase, and a half width of an X-ray diffraction peak from the (211) plane is 3.1° or less. As used herein, the term “tempered martensite phase” includes, in addition to the common tempered martensite phase, those in which a tempered bainite phase and/or a martensite phase is/are decomposed into a ferrite phase as a result of the release of C (carbon).

If the area ratio of the tempered martensite phase is less than 80% by area, the workability may deteriorate and the semi-hard magnetic properties may also deteriorate. The area ratio of the tempered martensite phase is preferably 85% by area or more, and more preferably 90% by area or more. The microstructure of the semi-hard magnetic steel material (or semi-hard magnetic steel component) according to the embodiments of the present invention can include retained austenite other than tempered martensite. The semi-hard magnetic steel material (or semi-hard magnetic steel component) according to the embodiments of the present invention can include carbides, sulfides, nitrides and oxides. Based on the microstructure and compound (hereinafter sometimes referred to as “microstructure, etc.”) thereof, the area ratio of the tempered martensite phase may be calculated. However, in view of the composition of the semi-hard magnetic steel (or semi-hard magnetic steel component) according to the embodiments of the present invention, it is assumed that the total area ratio of sulfides, nitrides and oxides is very small (for example, the total area ratio can be less than 3%). Therefore, the area ratio of the tempered martensitic phase in the embodiments of the present invention is calculated using the following equation (1).

$${f}_{m} = 100 - {f}_{γ} - {f}_{θ} \qquad ( 1 )$$

In the equation (1), fₘ is an area ratio (%) of the tempered martensite phase, f_{γ} is an area ratio (%) of the retained austenite phase, and f_{θ} is an area ratio (%) of the carbides.

In the above equation (1), f_{θ} can be determined as follows.

Samples are taken so that the cross-section of the semi-hard magnetic steel material (or semi-hard magnetic steel component) can be observed. Each sample is embedded in a resin and then an observation surface is subjected to emery polishing as rough polishing and diamond buff polishing as finish polishing. To dissolve carbides, the observation surface is further subjected to electropolishing (etchant: aqueous sodium picrate solution). Using a scanning electron microscope (SEM), an image is acquired from the observation surface at a magnification of 5,000 to 10,000 times. After binarizing the image using image analysis software, f_{θ} is calculated using the black portion as the area of the carbides.

It is noted that the calculation results of f_{θ} of the semi-hard magnetic steel material (or semi-hard magnetic steel component) according to the embodiments of the present invention do not significantly vary depending on the observation position. However, since there is a non-zero possibility that the degree of hardening on the steel surface varies depending on the method of quenching, compared to the degree of hardening at other positions, it is preferred to observe the vicinity of the position which is distant from the steel surface to some extent (for example, 2.0 mm or more) in the direction perpendicular to the steel surface from the steel surface towards the inside of the steel (for example, within a range of 1.0 mm centered on the position distant). In a small sample in which the position at least 2.0 mm or more away in the direction perpendicular to the steel surface toward the inside of the steel may not be the measurement center, it is preferred to observe the vicinity of the position which is maximally distant in the direction perpendicular to the steel surface.

In the above equation (1), f_{γ} can be determined as follows.

Samples are taken so that the cross-section of the semi-hard magnetic steel material (or semi-hard magnetic steel component) can be observed. Each sample is embedded in a resin and then a measurement surface is subjected to emery polishing as rough polishing and diamond buff polishing as finish polishing. From the measurement surface, an X-ray diffraction pattern is acquired using position sensitive proportional counter (PSPC) Micro-area X-ray stress measurement system (manufactured by Rigaku Corporation). The measurement conditions are as follows: target: Cr, acceleration voltage: 40 kV, acceleration current: 40 mA, collimator: φ1.0 mm, and measurement time: 100 seconds. Then, f_{γ} is determined by the following equation (2).

$${f}_{γ} / 100 = {I}_{γ} / ( {RI}_{α} + {I}_{γ} ) \qquad ( 2 )$$

In the above equation (2), I_{γ} is an integral intensity of peaks located at 1190 to 138° in an X-ray diffraction pattern, I_{α} is an integral intensity of peaks present at 148° to 165° in an X-ray diffraction pattern, R is a constant depending on a diffraction angle, a diffraction surface and the type of materials, and R may be 0.36746 as long as the measurement is performed by the above apparatus under the above conditions.

It is noted that the measurement results of the semi-hard magnetic steel material (or semi-hard magnetic steel component) according to the embodiments of the present invention do not significantly vary depending on the measurement position. However, since there is a non-zero possibility that the degree of hardening on the steel surface varies depending on the method of quenching, compared to the degree of hardening at other positions, it is preferred to use, as the measurement center, the vicinity of the position which is distant from the steel surface to some extent (for example, 2.0 mm or more) in the direction perpendicular to the steel surface from the steel surface towards the inside of the steel. In a small sample in which the position at least 2.0 mm or more away in the direction perpendicular to the steel surface toward the inside of the steel may not be the measurement center, it is preferred to use, as the measurement center, the vicinity of the position which is maximally distant in the direction perpendicular to the steel surface.

If the half width of the X-ray diffraction peak from the (211) plane is more than 3.1°, the steel becomes hard, leading to deterioration of the workability, and/or the magnetic moment of the parent phase reduces, leading to deterioration of the semi-hard magnetic properties. The half peak width is preferably 2.8° or less, more preferably 2.6° or less, still more preferably 2.4° or less, and yet more preferably 2.1° or less. The lower limit of the peak half width is not particularly limited, but is generally about 0.1° in view of the composition and the production conditions according to the embodiments of the present invention.

With respect to the above, although almost the same trend is observed when measuring any crystal orientation of a bcc phase such as a tempered martensitic phase, it was decided to define the half peak width of the (211) plane of the bcc phase, which enables clear identification of trend, as representative in the embodiments of the present invention.

The half width of the X-ray diffraction peak from the (211) plane is determined as follows.

Samples are taken so that the cross-section of the semi-hard magnetic steel material (or semi-hard magnetic steel component) can be observed. Each sample is embedded in a resin and then a measurement surface is subjected to emery polishing and/or diamond buff polishing. From the measurement surface, an X-ray diffraction pattern is acquired using PSPC Micro-area X-ray stress measurement system (manufactured by Rigaku Corporation), and the half width of peaks located at 148° to 165° is defined as the half width of the X-ray diffraction peak from the (211) plane. The measurement conditions are as follows: target: Cr, acceleration voltage: 40 kV, acceleration current: 40 mA, collimator: φ1.0 mm, and measurement time: 100 seconds.

It is noted that the measurement results of the semi-hard magnetic steel material (or semi-hard magnetic steel component) according to the embodiments of the present invention do not significantly vary depending on the measurement position, for the above measurement. However, since there is a non-zero possibility that the degree of hardening on the steel surface varies depending on the method of quenching, compared to the degree of hardening at other positions, it is preferred to use, as the measurement center, the vicinity of the position which is distant from the steel surface to some extent (for example, 2.0 mm or more) in the direction perpendicular to the steel surface from the steel surface towards the inside of the steel. In a small sample in which the position at least 2.0 mm or more away in the direction perpendicular to the steel surface toward the inside of the steel may not be the measurement center, it is preferred to use, as the measurement center, the vicinity of the position which is maximally distant in the direction perpendicular to the steel surface.

In the semi-hard magnetic steel material (or semi-hard magnetic steel component) according to the embodiments of the present invention, f_{θ} is preferably 4.00% or more. By setting f_{θ} at 4.00% or more, it is possible to decrease the amount of solid-soluted element such as C in the matrix phase, thus enabling suppression of an increase in hardness due to solid solution strengthening and an improvement in workability. Furthermore, carbides can suppress magnetic domain wall motion and contribute to an improvement in semi-hard magnetic properties. f_{θ} is preferably 4.05% or more, and more preferably 4.10% or more. To maintain the toughness, f_{θ} is preferably 20% or less.

In the semi-hard magnetic steel material (or semi-hard magnetic steel component) according to the embodiments of the present invention, f_{γ} is preferably 10.0% or less. By setting f_{γ} at 10.0% or less, high magnetic moment can be obtained, thus enabling an improvement in semi-hard magnetic properties. f_{γ} is preferably 8.0% or less, and more preferably 6.0% or less.

The semi-hard magnetic steel material (or semi-hard magnetic steel component) according to the embodiments of the present invention can exhibit sufficient workability and sufficient semi-hard magnetic properties. Specifically, it can exhibit a Vickers hardness of 570 or less as sufficient workability, and a squareness ratio (Br/B10k) of 0.760 or more as sufficient semi-hard magnetic properties. The Vickers hardness is preferably 470 or less, and more preferably 450 or less, and the squareness ratio (Br/B10k) is preferably 0.835 or more. “Br” is a residual magnetic flux density (unit: T), and “B10k” is a residual magnetic flux density (unit: T) at a magnetic field of 10 kA/m.

The semi-hard magnetic steel material (or semi-hard magnetic steel component) according to the embodiments of the present invention can be produced by subjecting the steel material (or steel component) with the above composition to quenching and tempering treatments. The steel material with the above composition can be obtained, for example, by melting in accordance with a conventional melting method so as to satisfy the above composition, and appropriately performing casting, hot rolling, secondary processing (wire drawing, annealing). The steel component with the above composition can be obtained, for example, by melting in accordance with a conventional melting method so as to satisfy the above composition, appropriately performing casting, hot rolling, secondary processing (wire drawing, annealing), and performing component forming such as forging or cutting. In the case of performing a quenching and tempering treatment after component forming, since the microstructure, etc. is reset by the quenching treatment, the component forming before the quenching and tempering treatment does not exert an influence on the requirements such as microstructure defined in the embodiments of the present invention. The semi-hard magnetic steel component according to the embodiments of the present invention may be produced by subjecting a steel component with the above composition to a quenching and tempering treatment, or may be produced by melting in accordance with a conventional melting method so as to satisfy the above composition, appropriately performing casting, hot rolling, secondary processing (wire drawing, annealing), subjecting to a quenching and tempering treatment, and performing component forming such as forging or cutting. The desired conditions for component forming may be appropriately set depending on the required properties of various components. To obtain a microstructure including 80% by area or more of a tempered martensite phase in which a half width of an X-ray diffraction peak from the (211) plane is 3.1° or less, there is a need to adjust to the above composition, and to adjust the temperature for high-temperature holding during the quenching and tempering treatment to 780° C. to 1,030° C. and to adjust the temperature for high-temperature holding of the tempering treatment to 480° C. to 680° C. The temperature for high-temperature holding during the quenching treatment is preferably 780° C. to 950° C. However, when the temperature for high-temperature holding during the quenching treatment is 900° C. or higher, since the dissolution of carbides present in the steel material (or the steel component) before the quenching treatment is promoted during high-temperature holding at the temperature, it is preferable that the temperature for high-temperature holding of the tempering treatment step is adjusted to 550° C. or higher, and carbides contributing to an improvement in semi-hard magnetic properties are precipitated in a large amount during the tempering treatment step. In view of further reducing the Vickers hardness, it is more preferable that the temperature for high-temperature holding of the tempering treatment step is 570° C. or higher.

The high-temperature holding time of the quenching treatment step and cooling after high-temperature holding, as well as the high-temperature holding time of the tempering treatment step and cooling after high-temperature holding may be optional. For example, in the quenching treatment step, the high-temperature holding time may adjusted to 10 to 90 minutes and cooling after the high-temperature holding may be oil quenching, and in the tempering step, the high-temperature holding time may be adjusted to 30 to 150 minutes, and cooling after the high-temperature holding may be water quenching or air cooling. The atmosphere during a heat treatment may be performed in any atmosphere since it does not cause significant change in microstructure.

Other steps may be included, for example, after the quenching and tempering treatment without departing from the scope of the object of the present invention. In the embodiments of the present invention, a heat treatment at lower than 480° C. may be included as other steps since significant influence is not exerted on the microstructure, etc. defined in the embodiments of the present invention if the temperature is lower than the temperature for high-temperature holding of the tempering treatment step. Since surface treatments such as a nitriding treatment and/or a plating treatment do not cause a change in microstructure, etc. inside the steel, these surface treatments may be included as other steps. In the method for producing a semi-hard magnetic steel component according to the embodiments of the present invention, component forming may be included as other steps as long as requirements of the embodiments of the present invention are satisfied.

The semi-hard magnetic steel component according to the embodiments of the present invention can be suitably used as a composite magnetic component (component composed of a plurality of members, at least a part of which has magnetism) such as relay (latching relay, ferreed), reed switch, memory, motor (external rotor, internal rotor), electromagnetic clutch (mover, stator) and electromagnetic brake by subjecting to appropriate component forming. The composite magnetic component including the semi-rigid magnetic steel component according to the embodiments of the present invention is industrially useful because of including the steel component having sufficient semi-hard magnetic properties.

### EXAMPLES

Examples of the present invention will be more specifically described by way of Examples. The embodiments of the present invention are not limited by the following Examples, and it is possible to implement the embodiments with modifications within the range that can meet the gist of the present disclosure as described above and below, all of these modifications being within the scope of the present disclosure. In the following Examples, the steel material (rod material) is formed into a ring before the quenching and tempering treatment and then properties are evaluated, namely, the evaluation results of the “steel component” are shown. However, as mentioned above, the presence or absence of component forming before the quenching and tempering treatment does not exert an influence on the evaluation results, and thus the Examples are believed to be positioned as showing the evaluation results of both “steel material” and “steel component”.

Steel pieces obtained by melting steels Nos. I to VIII with the composition shown in Table 1 in a converter furnace, followed by casting, or casting in an experimental furnace were hot-rolled or hot-forged to fabricate bars having a diameter of 40 to 65 mm. Subsequently, ring-shaped test pieces having an outer diameter of 38 mm, an inner diameter of 30 mm and a thickness of 4 mm were collected so that the circumferential direction of the test specimen and the circumferential direction of the bar were parallel and the center of the test specimen and the center of the rod were coincide with each other, and then subjected to a quenching and tempering treatment at the temperature shown in Table 2 using a laboratory furnace to obtain test specimens of tests Nos. 1 to 24. In Table 2, it is noted that “-” in columns of “quenching holding temperature” and “quenching holding temperature” indicate that quenching and tempering were not performed.

TABLE 1

| Steel | Composition [% by mass] | | | | | | | | | | |
|---|---|---|---|---|---|---|---|---|---|---|---|
| No. | C | Si | Mn | P | S | Cu | Ni | Mo | Cr | Al | N |
| I | 0.97 | 0.25 | 0.31 | 0.007 | 0.002 | 0.01 | 0.01 | 0.01 | 1.45 | 0.015 | 0.0045 |
| II | 0.20 | 0.25 | 0.75 | 0.005 | 0.005 | 0.01 | 0.01 | 0.01 | 1.05 | 0.030 | 0.0050 |
| III | 0.92 | 0.28 | 0.39 | 0.019 | 0.006 | 0.01 | 0.03 | 0.01 | 1.43 | 0.022 | 0.0053 |
| IV | 1.03 | 0.29 | 0.40 | 0.018 | 0.005 | 0.01 | 0.03 | 0.01 | 1.54 | 0.022 | 0.0047 |
| V | 0.63 | 0.25 | 0.29 | 0.006 | 0.006 | 0.01 | 0.01 | 0.01 | 1.46 | 0.026 | 0.0070 |
| VI | 0.99 | 0.25 | 0.30 | 0.006 | 0.005 | 0.01 | 0.01 | 0.01 | 0.89 | 0.024 | 0.0053 |
| VII | 0.64 | 0.14 | 0.14 | 0.005 | 0.005 | 0.01 | 0.02 | 0.01 | 0.86 | 0.024 | 0.0055 |
| VIII | 0.67 | 0.50 | 0.73 | 0.006 | 0.020 | 0.10 | 0.10 | 0.10 | 0.89 | 0.025 | 0.0060 |

*Balance being iron and inevitable impurities

TABLE 2

| | | Quenching | Tempering |
|---|---|---|---|
| | | holding | holding |
| Test | Steel | temperature | temperature |
| No. | No. | (° C.) | (° C.) |
| 1 | I | 800 | 600 |
| 2 | I | 840 | 600 |
| 3 | I | 900 | 600 |
| 4 | I | 800 | 500 |
| 5 | II | 900 | 600 |
| 6 | II | 900 | 500 |
| 7 | I | 1,000 | 500 |
| 8 | I | 1,000 | 600 |
| 9 | I | 900 | 500 |
| 10 | I | 800 | 400 |
| 11 | II | 900 | 400 |
| 12 | I | 900 | 400 |
| 13 | II | 900 | 300 |
| 14 | I | 800 | 300 |
| 15 | I | 840 | 300 |
| 16 | I | 900 | 300 |
| 17 | I | 840 | 200 |
| 18 | I | — | — |
| 19 | III | 840 | 600 |
| 20 | IV | 840 | 600 |
| 21 | V | 840 | 600 |
| 22 | VI | 840 | 600 |
| 23 | VII | 840 | 600 |
| 24 | VIII | 840 | 600 |

For test specimens of tests Nos. 1 to 24, fₘ, f_{γ}, f_{θ}, a half width of an X-ray diffraction peak from the (211) plane, a coercivity, a squareness ratio and a Vickers hardness were determined by the following method.

[fₘ and f_{γ}]

Samples were taken so that the cross-section (4 mm×4 mm) perpendicular to the circumferential direction of the ring-shaped test piece could be observed. Each sample was embedded in a resin and then a measurement surface was subjected to emery polishing as rough polishing and diamond buff polishing as finish polishing. From the measurement surface, an X-ray diffraction pattern was acquired using PSPC Micro-area X-ray stress measurement system (manufactured by Rigaku Corporation). The measurement conditions were as follows: target: Cr, acceleration voltage: 40 kV, acceleration current: 40 mA, collimator: φ1.0 mm, measurement time: 100 seconds, and measurement position: two points near the center of the measurement surface.

For two measurement positions, fₘ and f_{γ} were determined using the equations (1) and (2) and f_{θ} mentioned below, and an average value of two points were mentioned in Table 3 below. In the equation (2), R was 0.36746.

[f_{θ} ]

Samples were taken so that the cross-section (4 mm×4 mm) perpendicular to the circumferential direction of the ring-shaped test piece could be observed. Each sample was embedded in a resin and then a measurement surface was subjected to emery polishing as rough polishing and diamond buff polishing as finish polishing. To dissolve carbides, the observation surface was further subjected to electropolishing (etchant: aqueous sodium picrate solution). Using a scanning electron microscope (SEM), an image was acquired three fields of view from the vicinity of the center of the observation surface (within a range of 1.0 mm from the center) at a magnification of 5,000 times (field area: 217 μm²) or 10,000 times (filed area: 108.5 μm²). After binarizing the image using image analysis software, f_{θ} was calculated using the black portion as the area of the carbides.

[Half Width of X-Ray Diffraction Peak from (211) Plane]

Samples were taken so that the cross-section (4 mm×4 mm) perpendicular to the circumferential direction of the ring-shaped test piece could be observed. Each sample was embedded in a resin and then a measurement surface was subjected to emery polishing as rough polishing and diamond buff polishing as finish polishing. From the measurement surface, an X-ray diffraction pattern was acquired using PSPC Micro-area X-ray stress measurement system (manufactured by Rigaku Corporation) and the half width of peaks located at 148° to 165° was defined as the half width of the X-ray diffraction peak from the (211) plane. The measurement conditions were as follows: target: Cr, acceleration voltage: 40 kV, acceleration current: 40 mA, collimator: φ1.0 mm, measurement time: 100 seconds, and measurement position: two points near the center of the measurement surface. For two measurement positions, the above half widths were determined, and an average value of two points were mentioned in Table 3 below.

### [Coercivity and Squareness Ratio]

After winding was performed around the ring-shaped test piece to obtain a magnetization application coil and a magnetic flux detection coil, a B—H curve was measured at room temperature under the conditions of a maximum magnetic field of 10 kA/m using an automatic magnetization measurement device (DC magnetic measurement device BHS-40CD, manufactured by Riken Denshi Co., Ltd.), and then the coercivity (Hc) and the squareness ratio (Br/B10k) were determined.

### [Vickers Hardness]

Samples were taken so that the cross-section (4 mm×4 mm) perpendicular to the circumferential direction of the ring-shaped test piece could be observed. Each sample was embedded in a resin and subjected to diamond buff polishing as finish polishing, and then the Vickers hardness was measured under a load of 10 kgf for three points near the center of the cross-section, and an average value was employed.

The above measurement results are summarized in Table 3. The term “half width” in Table 3 refers to “half width of an X-ray diffraction peak from the (211) plane”.

TABLE 3

| | | | | | | Magnetic | | Work- |
|---|---|---|---|---|---|---|---|---|
| | | Microstructure | | | | properties | | ability |
| | | | | | Half | | Br/ | Vickers |
| Test | Steel | fₘ | f_{γ} | f_{θ} | width | Hc | B10k | hardness |
| No. | No. | (%) | (%) | (%) | (°) | (A/m) | — | — |
| 1 | I | 91 | 1.5 | 7.21 | 1.6 | 1,591 | 0.853 | 335 |
| 2 | I | 92 | 1.5 | 6.16 | 1.6 | 1,467 | 0.865 | 349 |
| 3 | I | 95 | 1.2 | 4.11 | 1.9 | 2,219 | 0.840 | 407 |
| 4 | I | 94 | 1.3 | 4.66 | 2.2 | 1,728 | 0.866 | 461 |
| 5 | II | 96 | 1.6 | 2.81 | 1.9 | 891 | 0.834 | 287 |
| 6 | II | 95 | 1.5 | 3.78 | 2.2 | 940 | 0.794 | 339 |
| 7 | I | 97 | 1.4 | 1.50 | 2.0 | 2,201 | 0.826 | 405 |
| 8 | I | 96 | 1.7 | 2.02 | 2.3 | 1,775 | 0.777 | 463 |
| 9 | I | 95 | 1.0 | 3.58 | 2.3 | 1,935 | 0.829 | 473 |
| 10 | I | 95 | 1.5 | 3.78 | 3.2 | 1,812 | 0.791 | 579 |
| 11 | II | 95 | 1.8 | 2.88 | 3.6 | 1,290 | 0.620 | 421 |
| 12 | I | 95 | 1.0 | 3.84 | 3.9 | 1,954 | 0.717 | 608 |
| 13 | II | 97 | 1.8 | 1.52 | 4.2 | 1,443 | 0.692 | 467 |
| 14 | I | 97 | 0.5 | 2.33 | 4.7 | 1,983 | 0.750 | 655 |
| 15 | I | 96 | 1.2 | 2.67 | 5.4 | 1,996 | 0.749 | 701 |
| 16 | I | 96 | 1.8 | 2.30 | 5.5 | 2,052 | 0.685 | 680 |
| 17 | I | 88 | 10.4 | 2.00 | 6.6 | 3,538 | 0.734 | 779 |
| 18 | I | — | — | — | 1.5 | 1,764 | 0.523 | 352 |
| 19 | III | 92 | 1.7 | 6.00 | 1.6 | 1,715 | 0.871 | 344 |
| 20 | IV | 91 | 1.7 | 7.40 | 1.6 | 1,713 | 0.874 | 347 |
| 21 | V | 92 | 1.6 | 6.81 | 1.7 | 1,665 | 0.841 | 358 |
| 22 | VI | 88 | 1.8 | 10.00 | 1.6 | 1,634 | 0.864 | 329 |
| 23 | VII | 93 | 1.7 | 5.60 | 1.8 | 1,607 | 0.864 | 321 |
| 24 | VIII | 94 | 1.9 | 4.49 | 1.8 | 1,813 | 0.853 | 339 |

From the results in Table 3, the following can be discussed. In all the tests Nos. 1 to 9 and 19 to 24 in Table 3, the resulting steels satisfied requirements specified by the embodiments of the present invention and were low cost, and had sufficient workability (Vickers hardness: 570 or less) and sufficient semi-hard magnetic properties (squareness ratio (Br/B10k): 0.760 or more). In tests Nos. 1 to 4 and 19 to 24, since the carbon content was 0.25% by mass or more and the quenching holding temperature was 780 to 950° C., the resulting steels satisfied preferable requirements such as fₑ of 4.00% or more, and exhibited preferable Vickers hardness (470 or less) and preferable squareness ratio (Br/B10k): 0.835 or more. In tests Nos. 1 to 3 and 19 to 24, since the tempering holding temperature was 570 to 680° C., the resulting steels exhibited more preferable Vickers hardness (450 or less). In test No. 9, although the carbon content was 0.25% by mass or more and the quenching holding temperature was 900° C. and was within a range of 780 to 950° C., the tempering holding temperature was 500° C. and the tempering holding temperature was lower than 550° C. when the quenching holding temperature was 900° C. or higher, and thus the resulting steels did not satisfy preferable requirements such as f_{θ} of 4.00% or more.

Meanwhile, in tests Nos. 10 to 17 of Table 3, since the holding temperature during the tempering treatment was lower than 480° C. and did not satisfy requirements such as a half width of an X-ray diffraction peak from the (211) plane of 3.1° or less, the resulting steels did not exhibit sufficient workability or sufficient semi-hard magnetic properties.

Test No. 18 is an example in which hardening and quenching are not performed, and thus semi-hard magnetic properties (squareness ratio (Br/B10k)) are insufficient. However, similarly to tests Nos. 1 to 9 and 19 to 24, when quenching is performed at the temperature for high-temperature holding of 780° C. to 1,030° C., and tempering is performed at the temperature for high-temperature holding of 480° C. to 680° C., it becomes possible to satisfy requirements specified in the embodiments of the present invention, and thus the resulting steels exhibit sufficient workability and sufficient semi-hard magnetic properties.

The present application claims priority on Japanese Patent Application No. 2021-175794 filed on Oct. 27, 2021 and Japanese Patent Application No. 2022-111740 filed on Jul. 12, 2022, the entire contents of which are incorporated herein by reference.

1. A semi-hard magnetic steel component comprising:
C: 0.60% by mass or more and 1.50% by mass or less,
Si: more than 0% by mass and 0.75% by mass or less,
Mn: more than 0% by mass and 1.00% by mass or less,
P: more than 0% by mass and 0.050% by mass or less,
S: more than 0% by mass and 0.050% by mass or less,
Cu: more than 0% by mass and 0.30% by mass or less,
Ni: more than 0% by mass and 0.30% by mass or less,
Mo: more than 0% by mass and less than 0.30% by mass,
Cr: 0.85% by mass or more and 2.00% by mass or less,
Al: more than 0% by mass and 0.100% by mass or less, and
N: more than 0% by mass and 0.0100% by mass or less, with the balance being iron and inevitable impurities, wherein
80% by area or more of a tempered martensite phase is included,
a half width of an X-ray diffraction peak from a (211) plane is 3.1° or less,
an area ratio of carbides is 4.00% or more, and
a Vickers hardness is 470 or less.

2. The semi-hard magnetic steel component according to claim 1, comprising more than 0% by mass and less than 0.05% by mass of Cu.

3. The semi-hard magnetic steel component according to claim 1, comprising more than 0% by mass and less than 0.05% by mass of Ni.

4. The semi-hard magnetic steel component according to claim 1, comprising more than 0% by mass and less than 0.05% by mass of Mo.

5. The semi-hard magnetic steel component according to claim 1, wherein the Vickers hardness is 450 or less.

6. The semi-hard magnetic steel component according to claim 2, comprising more than 0% by mass and less than 0.05% by mass of Ni.

7. The semi-hard magnetic steel component according to claim 2, comprising more than 0% by mass and less than 0.05% by mass of Mo.

8. The semi-hard magnetic steel component according to claim 2, wherein the Vickers hardness is 450 or less.

9. The semi-hard magnetic steel component according to claim 3, comprising more than 0% by mass and less than 0.05% by mass of Mo.

10. The semi-hard magnetic steel component according to claim 3, wherein the Vickers hardness is 450 or less.

11. The semi-hard magnetic steel component according to claim 4, wherein the Vickers hardness is 450 or less.

12. The semi-hard magnetic steel component according to claim 6, comprising more than 0% by mass and less than 0.05% by mass of Mo.

13. The semi-hard magnetic steel component according to claim 6, wherein the Vickers hardness is 450 or less.

14. The semi-hard magnetic steel component according to claim 7, wherein the Vickers hardness is 450 or less.

15. The semi-hard magnetic steel component according to claim 9, wherein the Vickers hardness is 450 or less.

16. The semi-hard magnetic steel component according to claim 12, wherein the Vickers hardness is 450 or less.
